(19) United States
(12) Patent Application Publication
(10) Pub. No.: US 2010/0024147 A1
(43) Pub. Date: Feb. 4, 2010

(54) Offset paint roller

(76) Inventor: Ricky Wayne Watson, Tarpon Springs, FL (US)

Correspondence Address: RICKY WATSON, 1005 Coldstream Ct, Tarpon Springs, FL, 34689, US

(21) Appl. No.: 12/220,963

(22) Filed: Jul. 30, 2008

(51) Int. Cl. B05C 17/02

(52) U.S. Cl. 15/230.11

(57) ABSTRACT

In accordance with the present invention, There is a means provided to create an ergonomic roller paint brush to allow full motion of the wrist of the painter to the rolling assembly and full and even pressure applied to the painting surface this inventions allows the painter to view the layer of paint being applied during the painting session this invention removes the requirement to step on a step ladder or larger ladder in order to access the correct motion and force of the painter to place an even layer of paint on a ceiling surface this invention by allowing the angled access to furniture removes the lack of leverage that is created with straight angled extension rods when painting above or behind the furniture that is being painted this invention allows easier angles of painting a corner painting in the corner of the room being painted

### FIELD OF THE INVENTION

This application relates generally to paint roller apparatus, and more specifically to an improved paint roller frame this application also relates to improving the painting process using a paint roller apparatus this application also proves access and better leverage during the painting process and removing the requirement of a step ladder when painting ceilings

### BACKGROUND OF THE INVENTION

Currently there exist several problems with painting surfaces with a roller paint brush that have not been address or solved with easy and inexpensive solution to these problems the first unsolved problem is the problem of painting a ceiling surface with a standard roller paint brush the painter is required to step up on a ladder with an extension rod in his hands to push and pull the roller paint brush filled with paint on a ceiling this is very cumbersome process because the extension rod and paint brush and the painter arms are in center view of his vision when painting this requires the painter to step up and down the ladder and move left and right many times to insure proper coverage of paint and even applied paint to the ceiling surface because the painter is at the end of the extension rod he has little good leverage while painting ceiling surfaces with the extension rod and roller paint brush in hand the painter cannot paint behind a furniture or cabinet or easily the ceiling above the furniture or cabinet the painter is attempting to paint around when the handle is grasped in the form of the palm there is an angle created that is inconsistent to the wrist natural movement and the direction of motion that is required to use the paint roller there is needed even pressure and layering of paint on a surface this alignment of wrist joints and the angled needed to paint with are not parallel to each other and over time injury to the wrist and soreness of the wrist is created when the painter uses a standard roller paint brush when a painter attempts to paint a corner of a room the three angles that are needed to paint at those directions to layer paint with a standard brush the painter needs to adjust himself at many angles to get the correct angle to layer paint in the corner as needed

U.S. Pat. No. 3,273,192

U.S. Pat. No. 3,419,931

U.S. Pat. No. 5,207,755

U.S. Pat. No. 6,148,469

WO 2008/024120 PCT/US2006/035874

U.S. Pat. No. 3,273,192 this patent relates to the existing idea that you need to adjust the shaft to various angles to get an optimum position to apply paint. The problem with this solution is that the various angles used and available are not ergonomically correct and will not solve the problem on wrist strain that is experienced by the painter because the adjustability of the rotational joint in the shaft will created a random nature of the angle created and the possibility of the ergonomically correct angle being used is very small compared to the availability of all angles available to the painter this invention has created a adjustable joint with a locking mechanism in the shaft itself. This solution has created a weakness in the structure of the shaft, long term use the adjustable joint will lose its integrity and will not maintain its structure that it was created to maintain this invention has no permanent offset capability and when the shaft is in a straight configuration the user will encounter the problems of being unable to look at the paint being applied to the ceiling or surface because the arms and extension rod and the roller paint brush itself will conceal the layer of paint being applied this invention will not allow access behind a cabinet or furniture when the shaft is straight position. This will create a loss of leverage when attempting to paint surfaces when using this invention in a straight configuration the painter will have to access a step ladder or larger ladder to get optimum angle when it is required to paint a ceiling.

U.S. Pat. No. 3,419,931 this patent relates to the existing idea that you need to adjust the shaft to various angles to get an optimum position to apply paint. The problem with this solution is that the various angles used and available are not ergonomically correct and will not solve the problem on wrist strain that is experienced by the painter because the adjustability of the rotational joint in the shaft will created a random nature of the angle created and the possibility of the ergonomically correct angle being used is very small compared to the availability of all angles available to the painter this invention has created a adjustable joint with no locking mechanism in the shaft itself. This solution has created a weakness in the structure of the shaft because the nuts and bolts are used to secure the rotational joint, long term use of the nuts and bolts will lose its integrity and will not maintain its structure that it was created to maintain this invention has no permanent offset capability and when the shaft is in a straight configuration the user will encounter the problems of being unable to look at the paint being applied to the ceiling or surface because the arms and extension rod and the roller paint brush itself will conceal the layer of paint being applied this invention will not allow access behind a cabinet or furniture when the shaft is straight position. This will create a loss of leverage when attempting to paint surfaces when using this invention in a straight configuration the painter will have to access a step ladder or larger ladder to get optimum angle when it is required to paint a ceiling.

U.S. Pat. No. 5,207,755 this patent relates to the existing idea that you need to adjust the shaft to various angles to get an optimum position to apply paint. The problem with this solution is that the various angles used and available are not ergonomically correct and will not solve the problem on wrist strain that is experienced by the painter because the adjustability of the rotational joint in the shaft will created a random nature of the angle created and the possibility of the ergonomically correct angle being used is small compared to the availability of all angles available to the painter this invention has created a adjustable joint with complex locking mechanism in the shaft itself. This solution has created a weakness in the structure of the shaft because the locking mechanism itself is a single rivet shaft joint integrated in the shaft. this complex joint and adjustability of this invention is not economically viable for manufacturing production, by lacking a an single ergonomic angle with complete integrity of the shaft this invention will not be viable nor manufactured when the shaft is in a straight configuration the user will encounter the problems of being unable to look at the paint being applied to the ceiling or surface because the arms and extension rod and the roller paint brush itself will conceal the layer of paint being applied this invention will not allow access behind a cabinet or furniture when the shaft is straight position. This will create a loss of leverage when attempting to paint surfaces when using this invention in a straight configuration the painter will have to access a stepladder or larger ladder to get optimum angle when it is required to paint a ceiling.

U.S. Pat. No. 6,148,469 this patent relates to the existing idea that you need to adjust the shaft to various angles to get an optimum position to apply paint. The problem with this solution is that the single angle used to create an offset angle is not ergonomic and will not solve the problem on wrist strain that is experienced by the painter because the adjustability of the rotational joint in the shaft will not change the relative motion of the wrist this adjusting paint roller invention has a adjustable mechanism with pins and a rotational wheel within the frame of the paint roller this will in time allow the stresses of the shaft to force the adjusting mechanism to become loose. There are only tiny locking pins to secure the paint roller and a release spring mechanism that will only loosen once the spring becomes fatigued over time. This configuration of a adjustable angle in the shaft is expensive and would not be as inexpensive rugged and reliable at the present invention This invention has no permanent offset capability and when the shaft is in a straight configuration the user will encounter the problems of being unable to look at the paint being applied to the ceiling or surface because the arms and extension rod and the roller paint brush itself will conceal the layer of paint being applied this invention will not allow access behind a cabinet or furniture when the shaft is straight position. This will create a loss of leverage when attempting to paint surfaces when using this invention in a straight configuration the painter will have to access a step ladder or larger ladder to get optimum angle when it is required to paint a ceiling.

WO Patent 2008/024120 PCT/US2006/035874 is a paint roller frame and apparatus this invention is created from a single piece of rod this invention has no offset angle there is no creation of an ergonomic angle in the frame to allow full motion of the wrist there is claimed an ergonomic angle in the flexing direction of the wrist and absorption of energy in the shaft the angle created in the invention does not change the relative angle of the palm that the handle is grasped this lack of change in a offset angle will not solve the ergonomic problem of the flexing of the wrist and the direction of the applied paint from the roller paint brush assembly as the paint is being applied this shaft is a right angle relative from the handle to the paint roller assembly the user will encounter the problems of being unable to look at the paint being applied to the ceiling or surface because the arms and extension rod and the roller paint brush itself will conceal the layer of paint being applied this invention will not allow access behind a cabinet or furniture because the shaft is straight relative to the direction of applied paint. This will create a loss of leverage when attempting to paint surfaces when using this invention in a straight configuration the painter will have to access a stepladder or larger ladder to get optimum angle when it is required to paint a ceiling.

It is therefore an object of the invention to provide an ergonomic angle in the frame of the roller paint brush to provide full motion of the wrist of the painter during the painting process

It is another object of the invention to provide full view of the layer of paint being applied during the painting session

It is another object of the invention to provides access behind and over furniture during the painting session

It is another object of the invention to remove the requirement to step up on a step ladder or larger ladder in order to access the correct motion and apply an even layer of paint on a ceiling surface

it is another object of the invention to remove the lack of leverage created by the extension rod when painting over and behind furniture in the room that is being created

it is another object of the invention to provide an easier means of painting an corner by rotating the handle of the roller paint brush to the three axis that is required to paint in a corner of a room being painted

it is another object of the invention to provice an increase of the safety of the painter by removing the requirement of the painter to step up on a ladder to get the proper angle to paint the ceiling when possible

### SUMMARY OF THE INVENTION

In accordance with the present invention, There is a means provided to create an ergonomic roller paint brush by creating an angle on the shaft of the roller paint brush angled to allow full motion of the wrist of the painter to the rolling assembly and full and even pressure applied to the painting surface this inventions also allows the painter to view the layer of paint being applied during the painting session this invention also allows the painter to paint behind and over furniture during the painting process this invention also removes the requirement to step on a step ladder or larger ladder in order to access the correct motion and force of the painter wrist and arm motion to place an even layer of paint on a ceiling surface this invention by allowing the angled access to furniture removes the lack of leverage that is created with straight angled extension rods when painting above or behind the furniture that is being painted around this invention allows easier angles of painting a corner by rotating the handle or extension shaft of the roller paint brush to the three main axis of painting in the corner of the room being painted there is a increase of safety by removing the requirement of the painter to step up on a ladder to get correct painting angle to paint ceiling when access from the floor is possible

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a FIG. 1 is a offset paint roller that is ergonomic in structure to provide improvement to the painting process using a paint roller. FIG. 1 number 1 is screw threads that allow attachment to a extension pole FIG. 1 number 2 is a handle to hold the paint roller FIG. 1 number 3 is a ergonomic angle that allows the users wrist to remain parallel to the rolling paint applicator FIG. 1 number 4 is a resultant angle that is needed to maintain the 90 degree angle to the roller paint applicator FIG. 1 number 5 is the paint roller assembly to allow the paint roller sleeve to attach to the paint roller structure FIG. 1 number 6 is the paint roller sleeve that holds paint to be painted;

FIG. 2 is a perspective view of a FIG. 2 shows the relationship between the hand holding the angled offset paint roller and the natural hold of the grasp of a paint handle FIG. 2 number 7 shows the wrist joint FIG. 2 number 8 shows the parallel relationship between the flexing motion of the wrist joint and the FIG. 2 number 13 painting angle of the roller assembly FIG. 2 number 9 is the handle of the offset paint roller FIG. 2 number 10 is the ergonomic angle that allow the wrist joint flex in a natural motion to apply paint FIG. 2 number 11 is the resultant angle needed to maintain a 90 degree relationship to FIG. 2 number 12 paint roller assembly FIG. 2 number 13 is the rolling angle that paint is applied to a surface and is parallel to the FIG. 2 number 7 wrist joint FIG. 2 number 57 is the natural void and angle that is created when the hand grasps a paint handle;

FIG. 3 is a perspective view of a FIG. 3 show the standard design of a roller paint brush this shows that the angle used to connect the handle to the roller paint applicator is not a ergonomic angle FIG. 3 number 14 shows the wrist joint that flexes in a unnatural angle because of the requirement of the angle of the shaft that connects the handle to the roller paint applicator FIG. 3 number 15 shows the flexing direction of the wrist and its relative relationship to the FIG. 3 number 17 roller paint applicator direction FIG. 3 number 16 is the standard angle of the shaft that is angled in the center of the roller paint brush applicator FIG. 3 number 58 is the resultant angle that is required to allow the roller paint brush to be at a 90 degree relationship to the handle FIG. 3 number 59 is the 90 degree angle of the shaft to connect the roller paint assembly to the shaft;

FIG. 4 is a perspective view of a FIG. 4 shows a painter painting the corner of two walls and a ceiling and the relationship of the painter to the painting surface that is being painted FIG. 4 number 18 is the painter painting with the arm extended FIG. 4 number 19 is a wall that is being painted FIG. 4 number 20 is the offset roller paint brush FIG. 4 number 21 shows the offset roller paint brush easily seated in the corner of the two walls and ceiling structure FIG. 4 number 22 is the ceiling FIG. 4 number 23 is the adjacent wall;

FIG. 5 is a perspective view of a FIG. 5 shows how the offset roller paint brush is able to use its offset feature to paint behind a tall cabinet or other household furniture FIG. 5 number 24 is a drawer FIG. 5 number 25 is a drawer FIG. 5 number 26 is the outside edge of the dresser cabinet FIG. 5 number 27 is the applied paint that had been rolled on the wall FIG. 5 number 28 is the extension rod to extend the roller paint brush FIG. 5 number 29 is the offset roller paint brush FIG. 5 number 30 is the top layer of applied paint FIG. 5 number 31 is the top of the dresser cabinet FIG. 5 number 32 is a drawer FIG. 5 number 33 is a drawer;

FIG. 6 is a side view of a FIG. 6 shows the methods necessary to perform a ceiling painting using a standard roller paint brush FIG. 6 number 34 is a step ladder FIG. 6 number 35 is the extension pole with attached roller paint brush FIG. 6 number FIG. 6 number 36 is the direction of force that is applied to the roller paint brush to apply a even continuous coat of paint 37 is the ceiling being painted upon FIG. 6 number 38 is the extension pole with attached roller paint brush FIG. 6 number 39 shows the direction of force applied to the roller paint brush when standing in a fixed position underneath the ceiling with no ladder to provide a better means of applying a continuous coat of paint FIG. 6 number 40 is the ceiling that paint is being applied to FIG. 6 number 41 shows the natural arc that would normally be created when standing in a single position and applying paint to the ceiling;

FIG. 7 is a side view of a FIG. 7 number 42 is the extension rod that connects to the offset roller paint brush FIG. 7 number 43 is the offset roller paint brush FIG. 7 number 44 shows the offset roller paint bush evenly set on the ceiling FIG. 7 number 45 is the ceiling FIG. 7 number 46 shows the different lines of force that is created and creates the ability to apply a even coat of paint on a ceiling;

FIG. 8 is a perspective bottom view of a FIG. 8 shows the requirement of looking a the paint that is being applied in order to ascertain if the coverage is acceptable while painting FIG. 8 number 47 is the bottom of the layer of paint being applied FIG. 8 number 48 is the coat of paint being applied FIG. 8 number 49 is a extension rod FIG. 8 number 50 is the offset roller paint brush FIG. 8 number 51 is the overlapping that is required to maintain a continuous coverage of paint this requires the painter to verify current coverage FIG. 8 number 60 is the single direction of motion that the painter can minimize to the painter has the ability to see the coat of paint being applied without interference from his hands and the painting rods and roller assemblies FIG. 8 number 52 is the ceiling being painted FIG. 8 number 53 shows the motion of the painter while he is painting the ceiling using a standard roller paint brush and extension rod he has to move left and right to verify the correct coating of paint because the standard roller brush and extension rod are in his field of vision FIG. 8 number 54 is the standard roller paint brush FIG. 8 number 55 is the extension rod FIG. 8 number 56 is the end of the current coat of paint being applied;

FIG. 9 is a perspective view of a FIG. 9 is a alternate embodiment of the offset paint roller this is a reduction in the amount of bends in the frame of the paint roller to two bends in the frame FIG. 9 number 61 is the internal thread to allow a extension rod to screw into the handle of the paint roller FIG. 9 number 62 is a paint roller handle FIG. 9 number 63 is the ergonomic bend in the frame to allow the wrist of the painter to be parallel to the painting roller assembly FIG. 9 number 64 is the paint roller frame FIG. 9 number 65 is a 90 degree angle to allow the full movement painter to be aligned to the paint roller assembly FIG. 9 number 66 is the paint roller assembly;

FIG. 10 is a perspective view of a FIG. 10 is a alternative embodiment of the offset roller paint brush this embodiment has a single angle with allows the ergonomic movement of the painters wrist and proper alignment of the roller paint brush assembly to a painting surface FIG. 10 number 67 is the hollow handle with threads to allow the paint brush to be attached to a extension rod FIG. 10 number 68 is the handle of the roller paint brush FIG. 10 number 69 is the shaft of the roller paint brush to connect the handle to the roller paint brush assembly FIG. 10 number 70 is the ergonomic angle that allows proper movement of the wrist when painting a surface FIG. 10 number 71 is the roller paint brush assembly; and

FIG. 11 is a perspective view of a FIG. 11 shows the rotating assembly angled frame handle and the outer painting sleeve FIG. 11 number 72 is the painting sleeve FIG. 11 number 73 is the inside threads to allow a extension rod to be screwed in the handle FIG. 11 number 75 is the frame that attaches the rotating assembly to the handle FIG. 11 number 76 is the ergonomic angle to allow the painters wrist to be aligned parallel to the rotating painting assembly FIG. 11 number 77 is the resultant angle that is created to align the handle to the rotating assembly FIG. 11 number 78 is the angle of the frame to align the frame a 90 degrees to the rotating paint roller assembly FIG. 11 number 79 is the rotating joint FIG. 11 number 80 is the wire frame that creates pressure to secure the outer painting sleeve to the rotating assembly FIG. 11 number 81 is the frame extension that supports the rotating assembly on a consistent axis of rotation FIG. 11 number 82 is the end piece that terminates the frame and the rotating assembly.

For purposes of clarity and brevity, like elements and components will bear the same designations and numbering throughout the FIGURES.

### DESCRIPTION OF THE PREFERRED EMBODIMENT

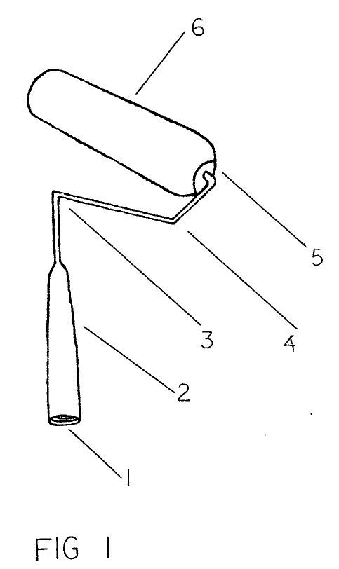

FIG. 1 is a perspective view of a FIG. 1 is a offset paint roller that is ergonomic in structure to provide improvement to the painting process using a paint roller. FIG. 1 number 1 is screw threads that allow attachment to a extension pole FIG. 1 number 2 is a handle 17 to hold the paint roller FIG. 1 number 3 is a ergonomic angle that allows the users wrist to remain parallel to the rolling paint applicator FIG. 1 number 4 is a resultant angle that is needed to maintain the 90 degree angle to the roller paint applicator FIG. 1 number 5 is the paint roller assembly 13 to allow the paint roller sleeve to attach to the paint roller structure FIG. 1 number 6 is the paint roller sleeve that holds paint to be painted.

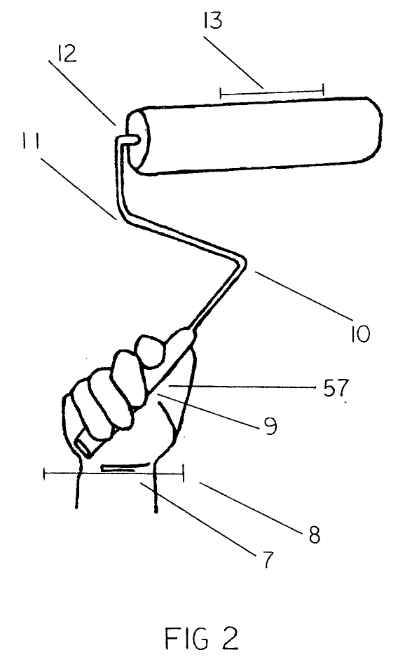

FIG. 2 is a perspective view of a FIG. 2 shows the relationship between the hand holding the angled offset paint roller and the natural hold of the grasp of a paint handle 17 FIG. 2 number 7 shows the wrist joint FIG. 2 number 8 shows the parallel relationship between the flexing motion of the wrist joint and the FIG. 2 number 13 painting angle of the roller assembly FIG. 2 number 9 is the handle 17 of the offset paint roller FIG. 2 number 10 is the ergonomic angle that allow the wrist joint flex in a natural motion to apply paint FIG. 2 number 11 is the resultant angle needed to maintain a 90 degree relationship to FIG. 2 number 12 paint roller assembly 13 FIG. 2 number 13 is the rolling angle that paint is applied to a surface and is parallel to the FIG. 2 number 7 wrist joint FIG. 2 number 57 is the natural void and angle that is created when the hand grasps a paint handle 17

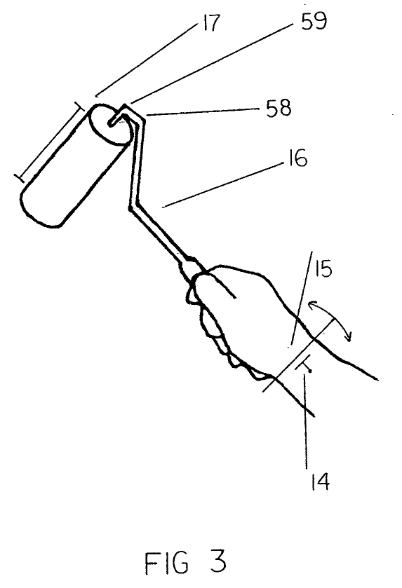

FIG. 3 is a perspective view of a FIG. 3 show the standard design of a roller paint brush this shows that the angle used to connect the handle 17 to the roller paint applicator is not a ergonomic angle FIG. 3 number 14 shows the wrist joint that flexes in a unnatural angle because of the requirement of the angle of the shaft that connects the handle 17 to the roller paint applicator FIG. 3 number 15 shows the flexing direction of the wrist and its relative relationship to the FIG. 3 number 17 roller paint applicator direction FIG. 3 number 16 is the standard angle of the shaft that is angled in the center of the roller paint brush applicator FIG. 3 number 58 is the resultant angle that is required to allow the roller paint brush to be at a 90 degree relationship to the handle 17 FIG. 3 number 59 is the 90 degree angle of the shaft to connect the roller paint assembly to the shaft

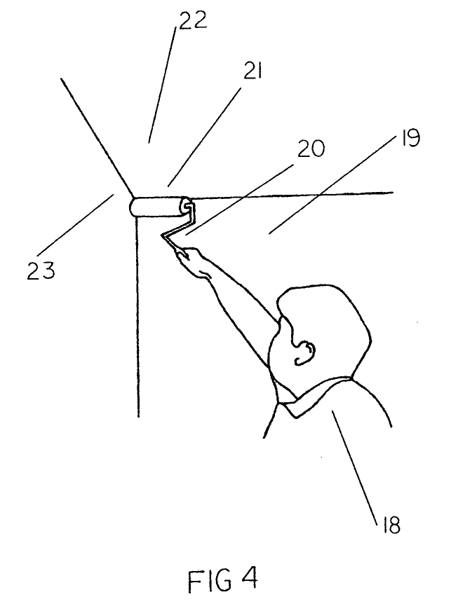

FIG. 4 is a perspective view of a FIG. 4 shows a painter painting the corner of two walls and a ceiling and the relationship of the painter to the painting surface that is being painted FIG. 4 number 18 is the painter painting with the arm extended FIG. 4 number 19 is a wall that is being painted FIG. 4 number 20 is the offset roller paint brush FIG. 4 number 21 shows the offset roller paint brush easily seated in the corner of the two walls and ceiling structure FIG. 4 number 22 is the ceiling FIG. 4 number 23 is the adjacent wall.

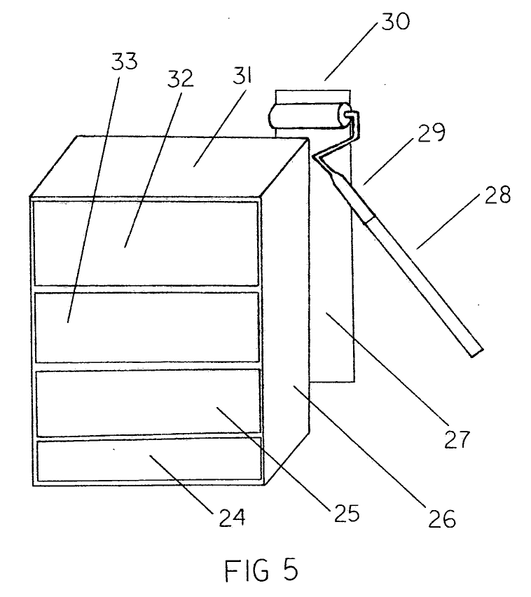

FIG. 5 is a perspective view of a FIG. 5 shows how the offset roller paint brush is able to use its offset feature to paint behind a tall cabinet or other household furniture FIG. 5 number 24 is a drawer FIG. 5 number 25 is a drawer FIG. 5 number 26 is the outside edge of the dresser cabinet FIG. 5 number 27 is the applied paint that had been rolled on the wall FIG. 5 number 28 is the extension rod to extend the roller paint brush FIG. 5 number 29 is the offset roller paint brush FIG. 5 number 30 is the top layer of applied paint FIG. 5 number 31 is the top of the dresser cabinet FIG. 5 number 32 is a drawer FIG. 5 number 33 is a drawer.

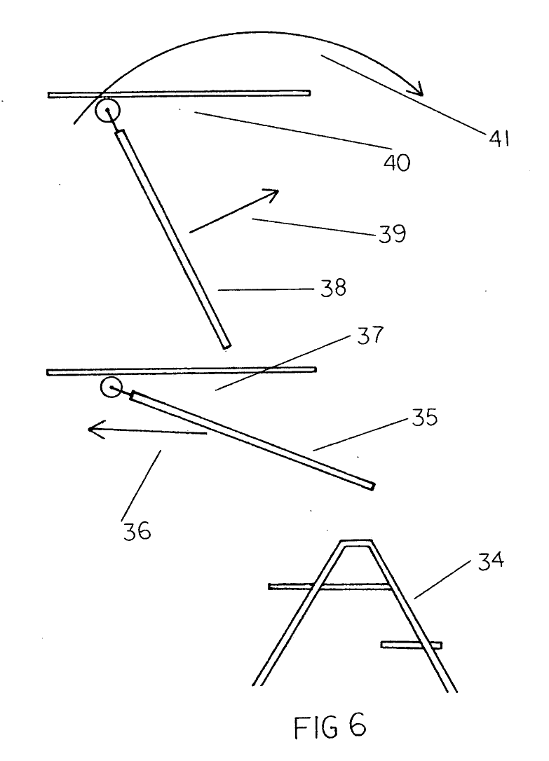

FIG. 6 is a side view of a FIG. 6 shows the methods necessary to perform a ceiling painting using a standard roller paint brush FIG. 6 number 34 is a step ladder FIG. 6 number 35 is the extension pole with attached roller paint brush FIG. 6 number FIG. 6 number 36 is the direction of force that is applied to the roller paint brush to apply a even continuous coat of paint 37 is the ceiling being painted upon FIG. 6 number 38 is the extension pole with attached roller paint brush FIG. 6 number 39 shows the direction of force applied to the roller paint brush when standing in a fixed position underneath the ceiling with no ladder to provide a better means of applying a continuous coat of paint FIG. 6 number 40 is the ceiling that paint is being applied to FIG. 6 number 41 shows the natural arc that would normally be created when standing in a single position and applying paint to the ceiling.

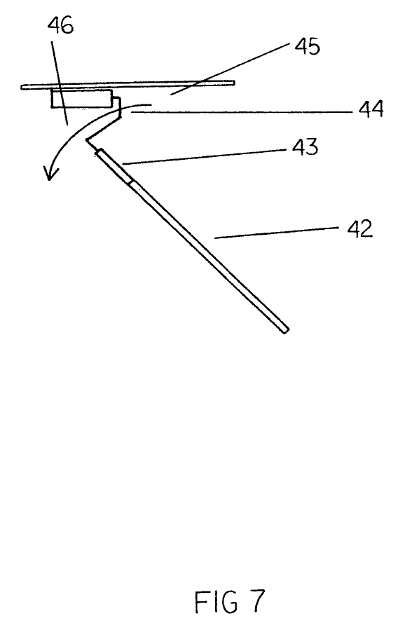

FIG. 7 is a side view of a FIG. 7 number 42 is the extension rod that connects to the offset roller paint brush FIG. 7 number 43 is the offset roller paint brush FIG. 7 number 44 shows the offset roller paint bush evenly set on the ceiling FIG. 7 number 45 is the ceiling FIG. 7 number 46 shows the different lines of force that is created and creates the ability to apply a even coat of paint on a ceiling.

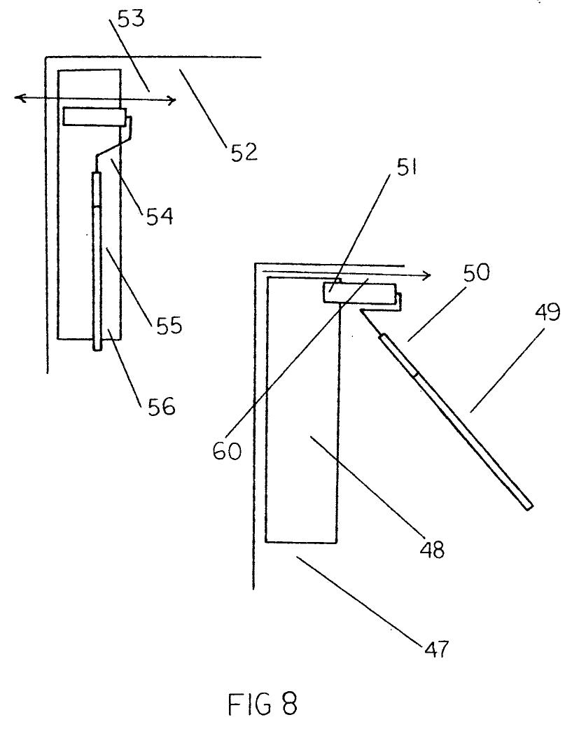

FIG. 8 is a perspective bottom view of a FIG. 8 shows the requirement of looking a the paint that is being applied in order to ascertain if the coverage is acceptable while painting FIG. 8 number 47 is the bottom of the layer of paint being applied FIG. 8 number 48 is the coat of paint being applied FIG. 8 number 49 is a extension rod FIG. 8 number 50 is the offset roller paint brush FIG. 8 number 51 is the overlapping that is required to maintain a continuous coverage of paint this requires the painter to verify current coverage FIG. 8 number 60 is the single direction of motion that the painter can minimize to the painter has the ability to see the coat of paint being applied without interference from his hands and the painting rods and roller assemblies FIG. 8 number 52 is the ceiling being painted FIG. 8 number 53 shows the motion of the painter while he is painting the ceiling using a standard roller paint brush and extension rod he has to move left and right to verify the correct coating of paint because the standard roller brush and extension rod are in his field of vision FIG. 8 number 54 is the standard roller paint brush FIG. 8 number 55 is the extension rod FIG. 8 number 56 is the end of the current coat of paint being applied.

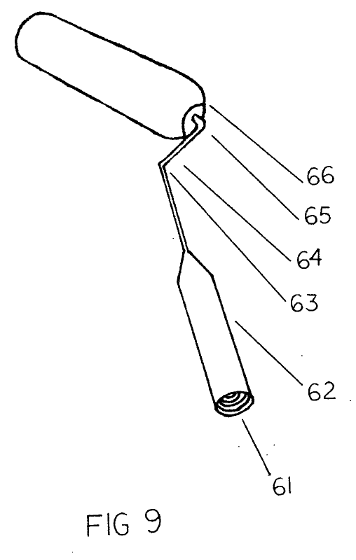

FIG. 9 is a perspective view of a FIG. 9 is a alternate embodiment of the offset paint roller this is a reduction in the amount of bends in the frame 19 of the paint roller to two bends in the frame 19 FIG. 9 number 61 is the internal thread to allow a extension rod to screw into the handle 17 of the paint roller FIG. 9 number 62 is a paint roller handle 17 FIG. 9 number 63 is the ergonomic bend in the frame 19 to allow the wrist of the painter to be parallel to the painting roller assembly FIG. 9 number 64 is the paint roller frame 19 FIG. 9 number 65 is a 90 degree angle to allow the full movement painter to be aligned to the paint roller assembly 13 FIG. 9 number 66 is the paint roller assembly 13.

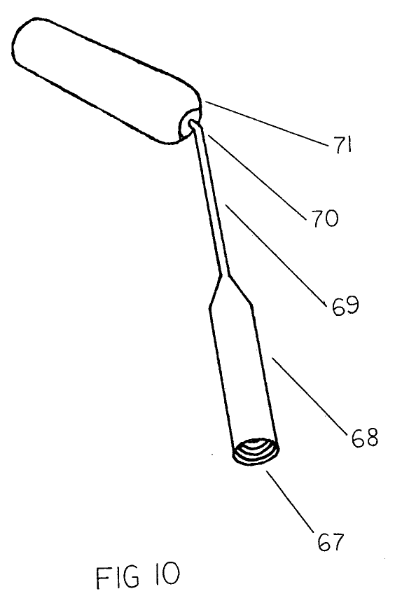

FIG. 10 is a perspective view of a FIG. 10 is a alternative embodiment of the offset roller paint brush this embodiment has a single angle with allows the ergonomic movement of the painters wrist and proper alignment of the roller paint brush assembly to a painting surface FIG. 10 number 67 is the hollow handle 17 with threads to allow the paint brush to be attached to a extension rod FIG. 10 number 68 is the handle 17 of the roller paint brush FIG. 10 number 69 is the shaft of the roller paint brush to connect the handle 17 to the roller paint brush assembly FIG. 10 number 70 is the ergonomic angle that allows proper movement of the wrist when painting a surface FIG. 10 number 71 is the roller paint brush assembly.

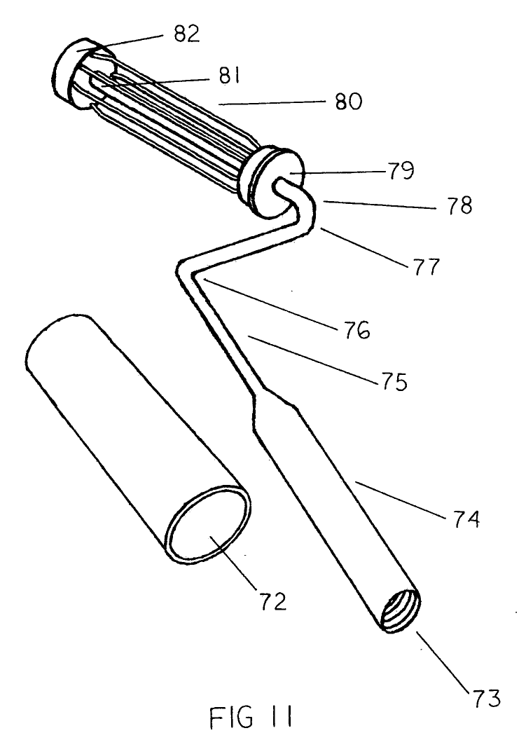

FIG. 11 is a perspective view of a FIG. 11 shows the rotating assembly angled frame 19 handle 17 and the outer painting sleeve FIG. 11 number 72 is the painting sleeve FIG. 11 number 73 is the inside threads to allow a extension rod to be screwed in the handle 17 FIG. 11 number 75 is the frame 19 that attaches the rotating assembly to the handle 17 FIG. 11 number 76 is the ergonomic angle to allow the painters wrist to be aligned parallel to the rotating painting assembly FIG. 11 number is the resultant angle that is created to align the handle 17 to the rotating assembly FIG. 11 number 78 is the angle of the frame 19 to align the frame 19 a 90 degrees to the rotating paint roller assembly 13 FIG. 11 number 79 is the rotating joint FIG. 11 number 80 is the wire frame 19 that creates pressure to secure the outer painting sleeve to the rotating assembly FIG. 11 number is the frame 19 extension that supports the rotating assembly on a consistent axis of rotation FIG. 11 number is the end piece that terminates the frame 19 and the rotating assembly.

The best method of the invention is figure number 1 drawings FIG. 1 number 1 is the hollow threaded end of the handle 17 to allow an extension rod to be added to the invention FIG. 2 number 2 is a handle 17 that is straight and securely fastened to the shaft FIG. 1 number 3 is a specific ergonomic angle of 65 degrees FIG. 1 number 4 is a angle that is 135 degrees FIG. 1 number 5 has an angle of 90 degrees FIG. 1 number 3 also is centered at the middle of the rolling paint assembly this is to provide maximum energy from the wrist and arm action into the roller paint assemble as it lays down paint. This invention can have manufactured several different angles at FIG. 1 number 3 to a 70 degree angle and a 60 degree angle this will provide a different selection of offset angles for various difference in painter palms and muscle structure. By having different solid core frames and not adjustable frames the integrity of the frame 19 is not compromised and the painter merely selects the appropriate angled offset paint roller for his own personal use.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. An offset paint roller for removing stress in the wrist of the painter while painting a surface and improving the painting process used by painters to lay down paint comprising:
means for support of the roller sleeve and rotating brush assembly;
means for create an offset angle to allow full motion of wrist joint, securely constructed to said means for support of the roller sleeve and rotating brush assembly;
means for painter to grasp the paint roller assembly; and
means for connect the handle to the rotating roller assembly, rigidly connected to said means for painter to grasp the paint roller assembly, and angularly constructed to said means for create an offset angle to allow full motion of wrist joint.

2. The offset paint roller in accordance with claim 1, wherein said means for support of the roller sleeve and rotating brush assembly comprises a paint roller assembly.

3. The offset paint roller in accordance with claim 1, wherein said means for create an offset angle to allow full motion of wrist joint comprises an ergonomic angle.

4. The offset paint roller in accordance with claim 1, wherein said means for painter to grasp the paint roller assembly comprises a handle.

5. The offset paint roller in accordance with claim 1, wherein said means for connect the handle to the rotating roller assembly comprises a frame.

6. An offset paint roller for removing stress in the wrist of the painter while painting a surface and improving the painting process used by painters to lay down paint comprising:
a paint roller assembly, for support of the roller sleeve and rotating brush assembly;
an ergonomic angle, for create an offset angle to allow full motion of wrist joint, securely constructed to said paint roller assembly;
a handle, for painter to grasp the paint roller assembly; and
a frame, for connect the handle to the rotating roller assembly, rigidly connected to said handle, and angularly constructed to said ergonomic angle.

7. The offset paint roller as recited in claim 6, further comprising:
a resulant angle, for to realign the frame to the roller assembly, rotationally connected to said paint roller assembly, and angularly constructed to said ergonomic angle.

8. The offset paint roller as recited in claim 6, further comprising:
a frame angle, for 90 degree bend in the frame to align the frame and handle to the roller assembly, rigidly connected to said resulant angle, and rotationally connected to said paint roller assembly.

9. The offset paint roller as recited in claim 6, further comprising:
an interior screw thread, for to attach an extension rod into the handle, inwardly constructed to said handle.

10. The offset paint roller as recited in claim 7, further comprising:
a frame angle, for 90 degree bend in the frame to align the frame and handle to the roller assembly, rigidly connected to said resulant angle, and rotationally connected to said paint roller assembly.

11. The offset paint roller as recited in claim 7, further comprising:
an interior screw thread, for to attach an extension rod into the handle, inwardly constructed to said handle.

12. The offset paint roller as recited in claim 8, further comprising:
an interior screw thread, for to attach an extension rod into the handle, inwardly constructed to said handle.

13. The offset paint roller as recited in claim 10, further comprising:
an interior screw thread, for to attach an extension rod into the handle, inwardly constructed to said handle.

14. An offset paint roller for removing stress in the wrist of the painter while painting a surface and improving the painting process used by painters to lay down paint comprising:
a paint roller assembly, for support of the roller sleeve and rotating brush assembly;
an ergonomic angle, for create an offset angle to allow full motion of wrist joint, securely constructed to said paint roller assembly;
a handle, for painter to grasp the paint roller assembly;
a frame, for connect the handle to the rotating roller assembly, rigidly connected to said handle, and angularly constructed to said ergonomic angle;
a resulant angle, for to realign the frame to the roller assembly, angularly constructed to said ergonomic angle, and rotationally connected to said paint roller assembly;
a frame angle, for 90 degree bend in the frame to align the frame and handle to the roller assembly, rigidly connected to said resulant angle, and rotationally connected to said paint roller assembly; and
an interior screw thread, for to attach an extension rod into the handle, inwardly constructed to said handle.
